(19) United States
(12) Patent Application Publication
(10) Pub. No.: US 2022/0224822 A1
(43) Pub. Date: Jul. 14, 2022

(54) MULTI-CAMERA SYSTEM, CONTROL VALUE CALCULATION METHOD, AND CONTROL APPARATUS

(71) Applicant: SONY CORPORATION, TOKYO (JP)

(72) Inventors: HIROAKI TAKAHASHI, TOKYO (JP); HIROSHI ORYOJI, TOKYO (JP); HISAYUKI TATENO, TOKYO (JP)

(21) Appl. No.: 17/285,398

(22) PCT Filed: Aug. 28, 2019
(86) PCT No.: PCT/JP2019/033628

§ 371 Date: Feb. 14, 2022

(30) Foreign Application Priority Data
Oct. 24, 2018 (JP) 2018-200398

(51) Int. Cl. H04N 5/232; H04N 13/282; H04N 13/296

(52) U.S. Cl. CPC H04N 5/23203; H04N 13/296; H04N 13/282

(57) ABSTRACT

In a multi-camera system (S), a control apparatus (1) includes: an acquisition unit (141) configured to acquire image data from each of a plurality of cameras (2); a generation unit (142) configured to generate three-dimensional shape information for a subject in a predetermined imaging area on the basis of a plurality of pieces of image data; a selection unit (143) configured to select at least a partial area of an area represented by the three-dimensional shape information of the subject as an area for calculating a control value of each of the plurality of cameras (2); a creation unit (144) configured to create mask information that is an image area used for control value calculation within the area selected by the selection unit (143) for each of the plurality of pieces of image data; and a calculation unit (145) configured to calculate the control value of each of the plurality of cameras (2) on the basis of the image data from each of the plurality of cameras (2) and the mask information.

### TECHNICAL FIELD

The present disclosure relates to a multi-camera system, a control value calculation method, and a control apparatus.

### BACKGROUND ART

In recent years, technological developments such as virtual reality (VR), augmented reality (AR), and Computer Vision have been actively carried out, and the need of imaging with a plurality of (for example, dozens of) cameras such as omnidirectional imaging and three-dimensional imaging (Volumetric imaging) have been increasing.

In a case where imaging is performed using a plurality of cameras, the work is complicated when control values such as exposure time, focal length, and white balance of each camera are set for each of individual cameras. Therefore, for example, there is a technique of estimating the three-dimensional shape of a subject from the focus distance information of the plurality of cameras and performing auto focus (AF) on the plurality of cameras on the basis of the three-dimensional shape.

### CITATION LIST

### Patent Document

Patent Document 1: Japanese Patent No. 5661373
Patent Document 2: Japanese Patent No. 6305232

### SUMMARY OF THE INVENTION

### Problems To Be Solved By The Invention

However, in the conventional technique described above, whether or not the area of the subject used for control value calculation is visible from each camera is not taken into consideration. Therefore, for example, there is room for improvement so that each control value is calculated on the basis of the depth information including the area where the subject is not imaged for each camera.

Therefore, in the present disclosure, the area of the subject used for control value calculation is determined in consideration of whether or not it is visible from each camera. Therefore, a multi-camera system, a control value calculation method, and a control apparatus that can calculate more appropriate control values for each camera are proposed.

### SOLUTIONS TO PROBLEMS

According to the present disclosure, the multi-camera system includes a plurality of cameras configured to image a predetermined imaging area from different directions and a control apparatus configured to receive image data from each of a plurality of the cameras and transmits a control signal including a control value to each of a plurality of the cameras. The control apparatus includes: an acquisition unit configured to acquire image data from each of a plurality of the cameras; a generation unit configured to generate three-dimensional shape information for a subject in the predetermined imaging area on the basis of a plurality of pieces of the image data; a selection unit configured to select at least a partial area of an area represented by the three-dimensional shape information of the subject as an area for calculating the control value of each of a plurality of the cameras; a creation unit configured to create mask information that is an image area used for control value calculation within the area selected by the selection unit for each of a plurality of pieces of the image data; and a calculation unit configured to calculate the control value of each of a plurality of the cameras on the basis of the image data from each of a plurality of the cameras and the mask information.

### BRIEF DESCRIPTION OF DRAWINGS

FIG. 1 is an overall configuration diagram of a multi-camera system according to a first embodiment of the present disclosure.

FIG. 2 is an explanatory diagram of processing content of each unit in a processing unit of a control apparatus according to the first embodiment of the present disclosure.

FIG. 3 is a diagram showing meta information of an object according to the first embodiment of the present disclosure.

FIG. 4 is a diagram showing variations of a selection area according to the first embodiment of the present disclosure.

FIG. 5 is a flowchart showing processing by the control apparatus according to the first embodiment of the present disclosure.

FIG. 6 is an explanatory diagram of processing content of each unit in a processing unit of a control apparatus according to a second embodiment of the present disclosure.

FIG. 7 is a schematic diagram showing each depth of field in the second embodiment of the present disclosure and a comparative example.

FIG. 8 is a flowchart showing processing by the control apparatus according to the second embodiment of the present disclosure.

FIG. 9 is an overall configuration diagram of a multi-camera system according to a third embodiment of the present disclosure.

FIG. 10 is an explanatory diagram of processing content of each unit in a processing unit of a control apparatus according to the third embodiment of the present disclosure.

FIG. 11 is a flowchart showing processing by the control apparatus according to the third embodiment of the present disclosure.

FIG. 12 is an explanatory diagram of a variation example of the third embodiment of the present disclosure.

FIG. 13 is an explanatory diagram of a variation example of the first embodiment of the present disclosure.

### MODE FOR CARRYING OUT THE INVENTION

Embodiments of the present disclosure will be described in detail below with reference to the drawings. Note that in each of the embodiments below, the same parts are designated by the same reference numerals and duplicate description will be omitted.

### First Embodiment

[Configuration of the Multi-Camera System According to the First Embodiment]

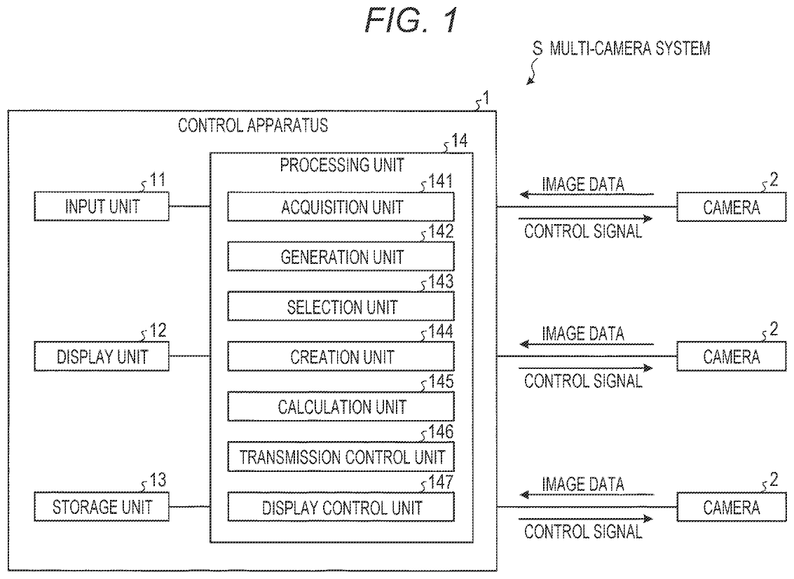

FIG. 1 is an overall configuration diagram of a multi-camera system S according to the first embodiment of the present disclosure. The multi-camera system S includes a control apparatus 1 and a plurality of cameras 2. The plurality of cameras 2 may include only one type of camera or may include a combination of types of cameras having different resolution, lens, and the like. Furthermore, a depth camera that calculates depth information, which is information regarding the distance to a subject, may be included. Description is given below on the assumption that the plurality of cameras 2 includes the depth camera. The plurality of cameras 2 (other than the depth camera. The same may apply below) images a predetermined imaging area from different directions and transmits the image data to the control apparatus 1. Furthermore, the depth camera transmits the depth information to the control apparatus 1.

The control apparatus 1 receives the image data and the depth information from each of the plurality of cameras 2, and also transmits a control signal including a control value to each of the cameras 2. The multi-camera system S is used, for example, for omnidirectional imaging and three-dimensional imaging (Volumetric imaging).

The control apparatus 1 is a computer apparatus, and includes an input unit 11, a display unit 12, a storage unit 13, and a processing unit 14. Note that the control apparatus 1 also includes a communication interface, but illustration and description thereof will be omitted for the sake of brevity. The input unit 11 is a means for the user to input information, for example, a keyboard or a mouse. The display unit 12 is a means for displaying information, for example, a liquid crystal display (LCD). The storage unit 13 is a means for storing information, for example, a random access memory (RAM), a read only memory (ROM), a hard disk drive (HDD), or the like.

The processing unit 14 is a means for operating information, for example, a central processing unit (CPU), a micro processing unit (MPU), or a graphics processing unit (GPU). The processing unit 14 includes, as main configurations, an acquisition unit 141, a generation unit 142, a selection unit 143, a creation unit 144, a calculation unit 145, a transmission control unit 146, and a display control unit 147.

The acquisition unit 141 acquires image data from each of the plurality of cameras 2. Furthermore, the acquisition unit 141 acquires the depth information from the depth camera. The generation unit 142 generates three-dimensional shape information for a subject in a predetermined imaging area on the basis of the plurality of pieces of image data and the depth information from the depth camera.

The selection unit 143 selects at least a partial area of the area represented by the three-dimensional shape information of the subject as the area for calculating the control value of each of the plurality of cameras 2.

For each of the plurality of pieces of image data, the creation unit 144 creates mask information, which is information regarding an imageable part of the subject area selected by the selection unit 143 (part visible from the camera where occlusion by another object (a state in which the object in front hides the object behind) does not occur).

The calculation unit 145 calculates the control value of each of the plurality of cameras 2 on the basis of the three-dimensional shape information of the subject. For example, the calculation unit 145 calculates the control value of each of the plurality of cameras 2 on the basis of the corresponding image data and the mask information created by the creation unit 144 on the basis of the three-dimensional shape. Since the mask information is two-dimensional information as to which pixel is used for control value calculation within the image of each camera 2, in addition to the fact that the mask information is easier to process than the three-dimensional information, there is an advantage that the mask information can be easily introduced because it is highly compatible with an existing control value calculation algorithm.

The transmission control unit 146 transmits a control signal including the control value calculated by the calculation unit 145 to the camera 2 corresponding to the control value. The display control unit 147 causes the display unit 12 to display information.

The units 141 to 147 in the processing unit 14 are realized, for example, by the CPU, MPU, or GPU executing a program stored inside the ROM or HDD with the RAM or the like as a work area. Furthermore, the units 141 to 147 may be realized by an integrated circuit such as an application specific integrated circuit (ASIC), a field programmable gate array (FPGA), and the like.

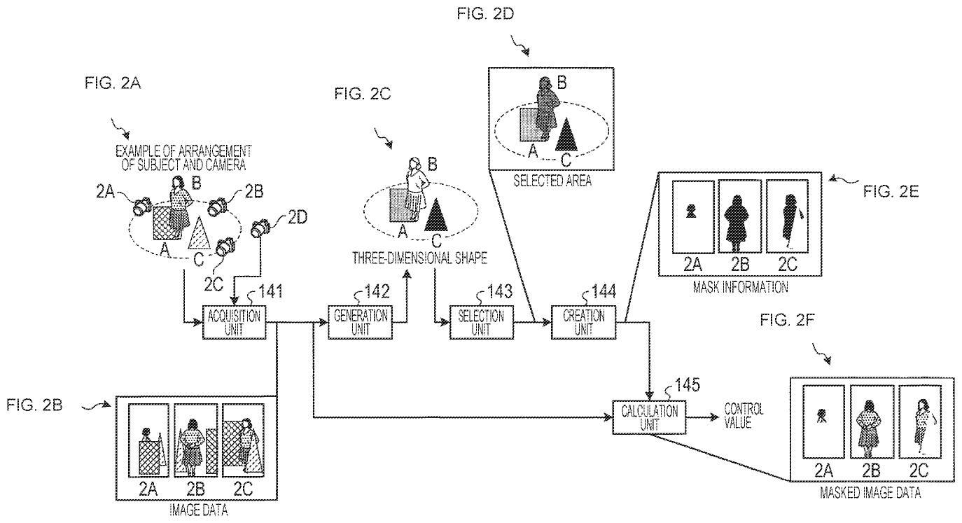

Next, an example of the processing content of the acquisition unit 141, the generation unit 142, the selection unit 143, the creation unit 144, and the calculation unit 145 will be described with reference to FIG. 2. FIG. 2 is an explanatory diagram of processing content of the units 141 to 145 in the processing unit 14 of the control apparatus 1 according to the first embodiment of the present disclosure.

Here, as an example, as shown in FIG. 2(a), a rectangular parallelepiped A, a person B, and a triangular pyramid C (hereinafter, also referred to as subjects A, B, and C) exist as subjects in a predetermined imaging area. Furthermore, cameras 2A, 2B, and 2C are arranged as the plurality of cameras 2 that images the predetermined imaging area from different directions, and furthermore a depth camera 2D is arranged.

In that case, first, the acquisition unit 141 acquires image data (FIG. 2(b)) from each of the cameras 2A, 2B, and 2C. Furthermore, the acquisition unit 141 acquires the depth information from the depth camera 2D. Note that, in order to speed up the subsequent processing, reduction processing may be performed on the obtained image data. The reduction processing may be, for example, a method that considers signal aliasing such as a Low Pass Filter, or decimation processing. This reduction processing may be performed by, for example, the acquisition unit 141, or may be realized as a sensor drive method at the time of imaging.

Next, the generation unit 142 generates three-dimensional shape information (FIG. 2(c)) for the subjects A, B, and C in the predetermined imaging area on the basis of the plurality of pieces of synchronized image data. The method of generating the three-dimensional shape information may be a general method of Computer Vision, and examples of the method include Multi View Stereo and Visual Hull. Furthermore, the format of three-dimensional shape may be a general format, and examples thereof include a polygon mesh and Point Cloud.

Next, the selection unit 143 selects at least a partial area of the area represented by the three-dimensional shape information of the subject as the area for calculating the control value of each of the cameras 2A, 2B, and 2C. FIG. 2(d) shows that the subject B has been selected. Note that this area selection may be performed manually or automatically. In the case of manual operation, the selection unit 143 may select an area on the basis of, for example, a selection operation on the screen (display unit 12) by the user. In that case, for example, it is sufficient if the user selects a rectangular area on the screen displaying the image of any of the cameras 2A, 2B, and 2C or specifies a part of the subject area on the touch panel by touch operation.

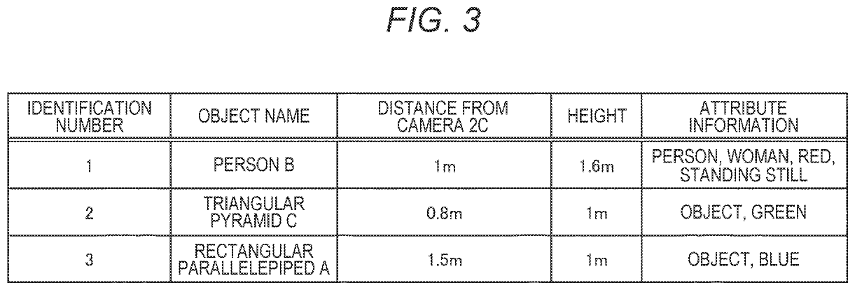

Furthermore, as another selection method, it may be performed on the basis of the information of area division performed in advance or in real time on the image, or the meta information of the added object. Here, FIG. 3 is a diagram showing meta information of an object according to the first embodiment of the present disclosure. As shown in FIG. 3, as an example of the meta information of the object, pieces of information including the identification number, the object name, the distance from the camera 2C, the height, and the attribute information are associated.

The attribute information is information that represents the characteristics of the object. By storing such meta information of object, for example, when the user inputs “a person in red clothes” as text information, the selection unit 143 can select the person B. As the usage of the meta information, it may be used as an attribute itself, or complicated conditions can be set in combination with a logical operation such as “a person in clothes in colors other than red”. In this way, by using the meta information of object including the attribute information, it is possible to realize advanced area selection. Note that the specific method of object recognition and area division is not particularly limited, and a general method may be used. For example, examples include, but are not limited to, a deep learning method represented by Semantic Instance Segmentation, which has been studied in the field of Computer Vision.

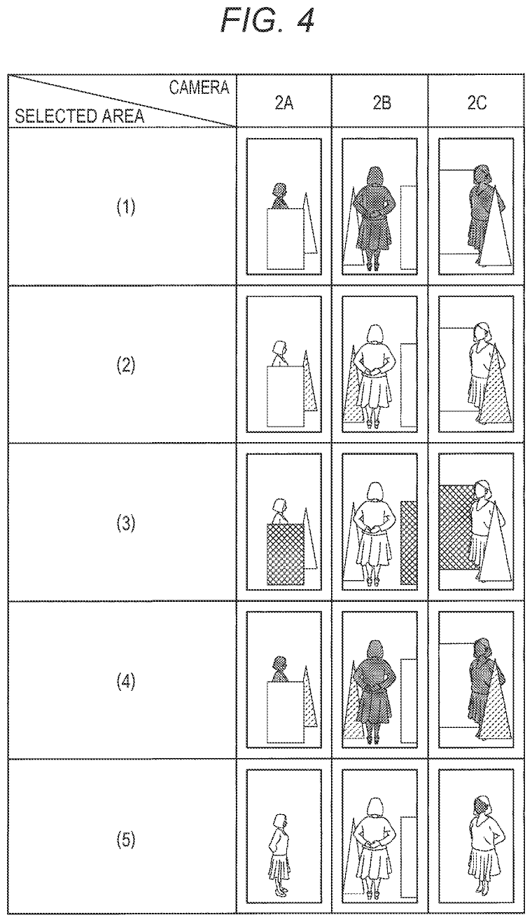

Furthermore, the area to be selected may be one or a plurality of the subjects A, B, and C. Furthermore, it may be the whole or a part of one subject. Here, FIG. 4 is a diagram showing variations of a selection area according to the first embodiment of the present disclosure. In FIG. 4, (1) shows that the selected area is the person B. (2) shows that the selected area is the triangular pyramid C. (3) shows that the selected area is the rectangular parallelepiped A. (4) shows that the selected area is the person B and the triangular pyramid C. (5) shows that the selected area is the face of the person B.

Note that the selected area may be specified for each of the plurality of cameras 2, or may be specified for some of the cameras 2. Furthermore, the selected area may be obtained as a union of the areas selected by a plurality of means, or may be obtained as an intersection.

Referring back to FIG. 2, next, the creation unit 144 creates the mask information (FIG. 2(e)), which is the information regarding the imageable part, which is visible from the camera 2, of the area selected by the selection unit 143 for each of the plurality of pieces of image data. The mask information for each camera 2 can be created on the basis of the three-dimensional shape information created by the generation unit 142 and the position information of each camera 2. For example, it can be obtained by using computer graphics (CG) or Computer Vision technology to project the three-dimensional shape of the subject onto the camera 2, which is a target, and determining whether or not each point on the surface of the selected subject is visible from the camera 2 in every direction within the viewing angle. As shown in FIG. 2(e), the mask information is two-dimensional information and excludes a non-imageable part (part invisible from the camera 2) of the selected subject B in the image data.

Next, the calculation unit 145 calculates the control value of each of the cameras 2A, 2B, and 2C on the basis of the corresponding image data and mask information. The masked image data shown in FIG. 2(f) is obtained by extracting the portion of the image data corresponding to the mask information. By calculating the control value of each of the cameras 2A, 2B, and 2C on the basis of the masked image data, the calculation unit 145 can acquire a plurality of pieces of image data having more uniform brightness and color for the selected subject. At this time, the calculation of the control value may be performed on the basis of the corresponding masked image data corresponding for each camera 2, or the control value of each camera 2 may be obtained from the entire information by integrally handling the masked image data of the plurality of cameras 2. On the other hand, in the conventional technique, for example, a plurality of pieces of image data in which the brightness and color are not uniform regarding a predetermined subject has been acquired by calculating the control value of each camera on the basis of the entire image of each of a plurality of images.

[Processing of the Control Apparatus 1 According to the First Embodiment]

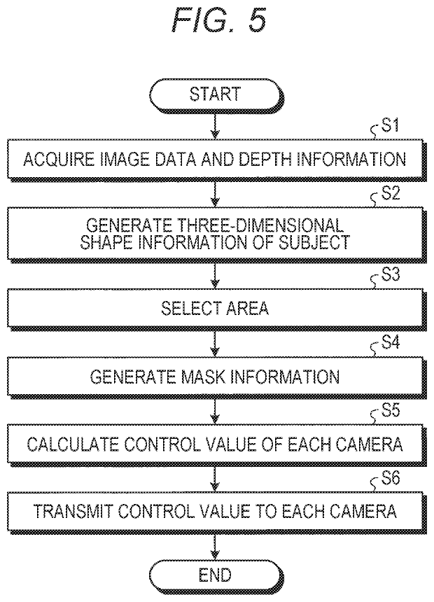

Next, the flow of processing by the control apparatus 1 will be described with reference to FIG. 5. FIG. 5 is a flowchart showing processing by the control apparatus 1 according to the first embodiment of the present disclosure. First, in step S1, the acquisition unit 141 acquires the image data from each of the cameras 2A, 2B, and 2C and also acquires the depth information from the depth camera 2D.

Next, in step S2, the generation unit 142 generates the three-dimensional shape information for a subject in a predetermined imaging area on the basis of the plurality of pieces of image data and the depth information from the depth camera 2D acquired in step S1.

Next, in step S3, the selection unit 143 selects at least a partial area of the area represented by the three-dimensional shape information of the subject as the area for calculating the control value of each of the plurality of cameras 2.

Next, in step S4, the creation unit 144 creates the mask information, which is the information regarding the imageable part of the area selected in step S3 for each of the plurality of pieces of image data.

Next, in step S5, the calculation unit 145 calculates the control value of each of the plurality of cameras 2 on the basis of the corresponding image data and mask information.

Next, in step S6, the transmission control unit 146 transmits a control signal including the control value calculated in step S5 to the camera 2 corresponding to the control value. Then, each of the plurality of cameras 2 performs imaging on the basis of the received control value.

In this way, with the multi-camera system S of the first embodiment, a more appropriate control value can be calculated by determining the area of the subject used for control value calculation in consideration of whether or not it is visible from each camera 2. Specifically, the control value of each of the plurality of cameras 2 can be calculated more appropriately on the basis of the three-dimensional shape information of a predetermined subject.

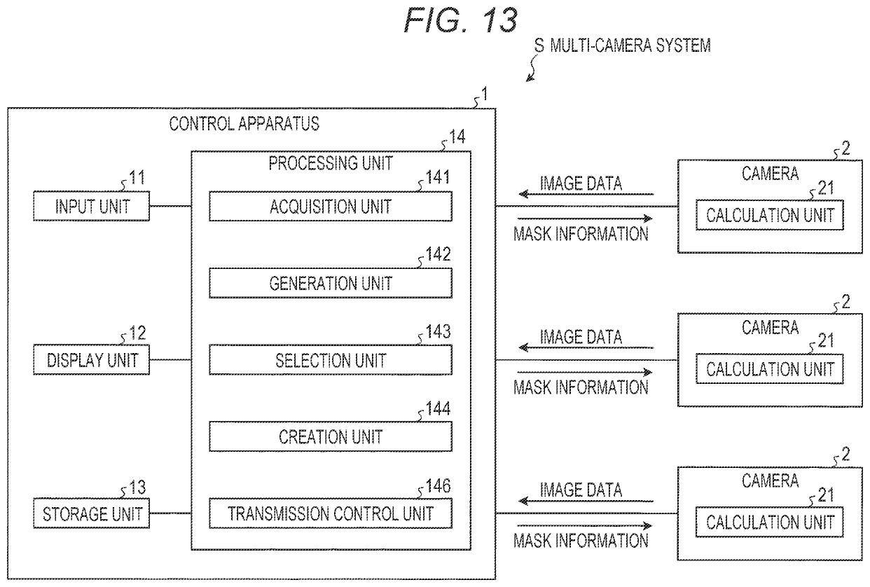

Here, a variation example of the first embodiment will be described with reference to FIG. 13. FIG. 13 is an explanatory diagram of a variation example of the first embodiment of the present disclosure. As shown in FIG. 13, when compared with FIG. 1, the calculation unit 145 and the display control unit 147 are removed from the processing unit 14 of the control apparatus 1, and a calculation unit 21 having a function similar to that of the calculation unit 145 is provided in each camera 2. Then, instead of the control signal, the control apparatus 1 may transfer the mask information created by the creation unit 144 to each camera 2, and control value calculation processing similar to step S5 of FIG. 5 may be performed by the calculation unit 21 of each camera 2. Furthermore, the method of realizing the processing including the control apparatus 1 and the camera 2 is not limited to this.

Referring back to the description of the operation and effect of the first embodiment, furthermore, because the control apparatus 1 can automatically appropriately calculate the control value of each of the plurality of cameras 2, the scalability of the number of cameras according to the usage can be realized while suppressing an increase in management load due to an increase in the number of cameras 2.

Furthermore, in the first embodiment, one depth camera is provided for the sake of brevity. However, with one piece of depth information, occlusion can occur when the viewpoint is changed, and false three-dimensional shape information can be generated. Therefore, it is more preferable to use a plurality of depth cameras and use a plurality of pieces of depth information.

Note that examples of the types of control value include exposure time, ISO sensitivity, aperture value (F), focal length, zoom magnification, white balance, and the like. The effect and the like regarding each control value in a case where the method of the first embodiment (hereinafter, also referred to as “the present method”) is executed will be described.

(Exposure Time)

By imaging with excessive or insufficient exposure time, pixel saturation or blocked-up shadows occurs and the image lacks the contrasts. On the other hand, it is difficult to set an appropriate exposure time in the entire area of the viewing angle in a scene with a wide dynamic range such as a spotlighted concert stage or outdoor sunny and shady places, and it is preferable to adjust the exposure time with reference to a predetermined subject in the angle of view. Therefore, especially, in the case of an image with a large variation in brightness, by using the present method, the exposure time is adjusted with the dynamic range narrowed with reference to a predetermined subject to reduce blown-out highlights and blocked-up shadows due to saturation, and images with a favorable SN ratio can be imaged.

(ISO Sensitivity)

Since there is an upper limit to the exposure time of one frame in a moving image and the like, in the case of imaging in dark places, it is common to adjust the conversion efficiency (analog gain) during AD conversion or adjust the brightness of the entire screen by increasing the gain after digitization. Therefore, especially, in the case of a scene with a wide dynamic range from a bright place to a dark place, imaging can be performed under conditions with the dynamic range narrowed with reference to a predetermined subject by limiting the area, which is a subject of each camera, by using the present method. Therefore, by adjusting the ISO sensitivity specifically for narrower brightness, unnecessary gain increase can be eliminated and an image with a favorable SN ratio can be imaged.

(Aperture Value (F))

Cameras have a depth of field (a range of depth that allows a subject to be imaged without blurring) according to the aperture of the lens. When the foreground and background are to be imaged simultaneously, for example, it is desirable to increase the aperture value and reduce the aperture to increase the depth of field, but the negative effect of reducing the aperture is that the amount of light decreases. As a result, it causes blocked-up shadows and a reduction in SN ratio. On the other hand, by using the present method, it is possible to narrow the range of depth in which the subject exists by performing imaging in a narrowed subject area. As a result, it is possible to image a bright image while maintaining the resolution by performing image with a minimum F with reference to a predetermined subject. In particular, in the case of an image with a large variation in depth from the foreground (front) to the background (back) (scenes in which multiple objects are scattered in space, scenes in which an elongated subject is arranged so as to become longer in the depth direction, or other scenes), the F setting tends to be large in order to image everything on the screen with the conventional method. By using the present method, it is possible to perform imaging with a small F value and a slightly open aperture setting, and the same scene can be imaged brightly in terms of a lens. As a result, the part brightened by the F setting can be allocated as the degree of freedom of other parameters for determining the exposure. For example, there is room for optimization depending on the purpose, such as shortening the exposure time to improve the response to moving subjects and lowering the ISO sensitivity to improve the SN ratio.

(Focal Length)

The optical system of a camera has a focal length that enables clear imaging of a subject with the highest resolution by focusing. Furthermore, since the focal length is located at approximately the center of the depth of field adjusted by the aperture, it is necessary to set it together with the aperture value in order to clearly image the entire subject. By using the present method, F is minimized by limiting the area of the subject and appropriately adjusting the value of focal length to the center of the depth distribution of the subject or the like, enabling optically brighter imaging as compared with the conventional method.

(Zoom Magnification)

In a typical camera system, the angle of view to be imaged is determined by the size of the sensor and the lens. On the other hand, since the resolution of the sensor is constant, when the lens is wide-angle, it is possible to perform imaging including the background, but the resolution becomes rough. By using the present method, it is possible to suppress the angle of view and obtain a high-resolution image of the subject by adjusting the angle of view with reference to a predetermined subject and performing imaging. In particular, in a scene where the subject is small with respect to the imaging area, a large effect can be obtained by using the present method.

(White Balance)

The human eye has a characteristic called chromatic adaptation. When the human is in a room with the same lighting, the eyes will get used to the color of the light to cancel it and can distinguish colors (for example, white) even in a room with different lighting conditions. White balance technology digitally realizes this function. In particular, in a scene of a multi-lighting environment with different colors, by using the present method, the number of lights for each camera can be limited, and an image with correct white balance and close to how it looks can be obtained.

### Second Embodiment

Next, a multi-camera system S of the second embodiment will be described. Duplicate description will be omitted as appropriate for matters similar to those of the first embodiment.

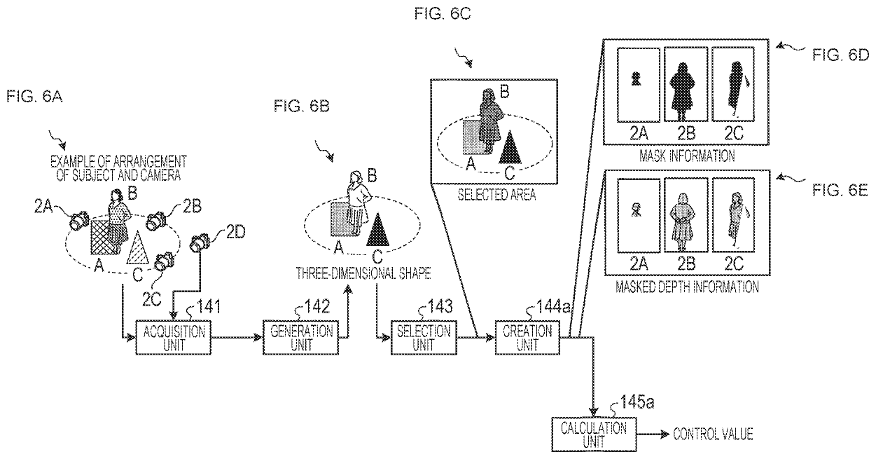

FIG. 6 is an explanatory diagram of processing content of units 141 to 145a in the processing unit 14 of the control apparatus 1 according to the second embodiment of the present disclosure. Note that a creation unit 144a and a calculation unit 145a are configurations corresponding to the creation unit 144 and the calculation unit 145 of FIG. 1, respectively.

Furthermore, similar to the case of FIG. 2, as shown in FIG. 6(a), it is assumed that the cameras 2A, 2B, and 2C and the depth camera 2D are arranged as the plurality of cameras 2.

The acquisition unit 141 acquires image data from each of the cameras 2A, 2B, and 2C and furthermore acquires depth information from the depth camera 2D. The generation unit 142 (FIG. 6(c)) and the selection unit 143 (FIG. 6(d)) are similar to those in the case of the first embodiment.

The creation unit 144a creates mask information (FIG. 6(e)) similar to the case of the first embodiment, and moreover creates depth information for each camera 2 and then creates masked depth information (FIG. 6(f)), which is a part corresponding to the mask information.

Furthermore, the calculation unit 145a calculates the control value of each of the plurality of cameras 2A, 2B, and 2C on the basis of the corresponding masked depth information. For example, the calculation unit 145a calculates at least one of the aperture value or the focal length of the camera as the control value.

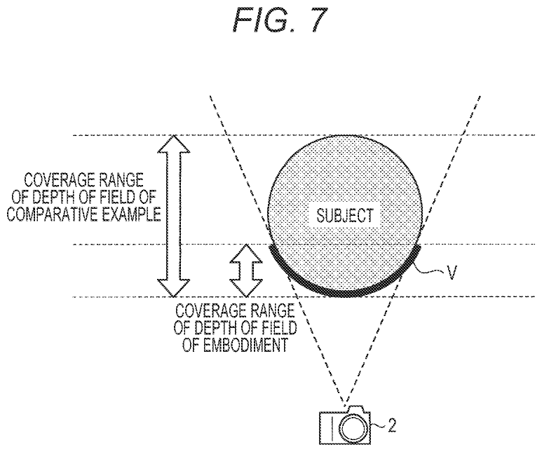

Here, FIG. 7 is a schematic diagram showing each depth of field in the second embodiment of the present disclosure and a comparative example. In a case where there is a subject, in the comparative example (conventional technique), the coverage range of the depth of field includes a non-imageable part on the basis of the depth information. On the other hand, the coverage range of the depth of field in the case of the second embodiment does not include a non-imageable part on the basis of the masked depth information (FIG. 2(f)) and corresponds only to an imageable part V. Therefore, an appropriate control value (particularly, aperture value and focal length) can be calculated.

Furthermore, in the second embodiment, the creation unit 144a may create selected area information (including non-imageable part), which is the information regarding the area selected by the selection unit 143 for each of the plurality of pieces of image data.

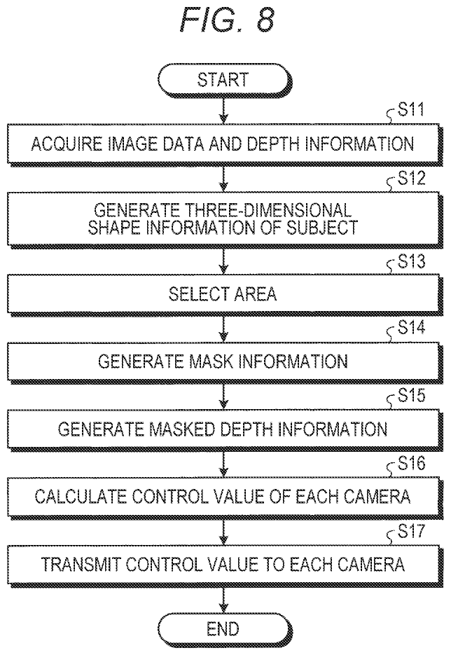

Next, the processing by the control apparatus 1 will be described with reference to FIG. 8. FIG. 8 is a flowchart showing processing by the control apparatus 1 according to the second embodiment of the present disclosure. Steps S11 to S14 are similar to steps S1 to S4 of FIG. 5. After step S14, in step S15, the creation unit 144a creates the depth information for each camera 2 on the basis of the three-dimensional shape information generated in step S12 and the information of each camera 2. The creation method may be a general method of Comuputer Vision, and for example, it is sufficient if the depth information is obtained by performing perspective projection transformation from relative position and orientation information of the plurality of cameras 2 and the three-dimensional shape information, which is called an external parameter, and the angle of view of the lens of the camera 2 and the sensor resolution information, which are called internal parameters. Moreover, the creation unit 144a creates the masked depth information, which is a part of the depth information corresponding to the mask information, on the basis of the obtained depth information and the mask information created in step S14.

Next, in step S16, the calculation unit 145a calculates the control value of each of the cameras 2A, 2B, and 2C on the basis of the corresponding masked depth information.

Next, in step S17, the transmission control unit 146 transmits a control signal including the control value calculated in step S16 to the camera 2 corresponding to the control value. Then, each of the plurality of cameras 2 performs imaging on the basis of the received control value.

As described above, with the multi-camera system S of the second embodiment, the control value of each of the plurality of cameras 2 can be calculated more appropriately on the basis of the masked depth information. For example, by changing the control value adjusted for the entire subject in the conventional technique to the control value adjusted to the area visible from the camera 2, the control values particularly the aperture value and the focal length can be calculated appropriately. Furthermore, by using the depth information, the control values of the aperture value and the focal length can be calculated directly without contrast AF using color images or the like, and therefore the control values can be calculated easily as compared with continuous AF or the like that takes multiple shots while changing the focus value and calculates the optimum focus value.

Note that in the second embodiment, one depth camera is provided for the sake of brevity. However, with one piece of depth information, occlusion can occur when the viewpoint is changed, and false three-dimensional shape information can be generated. Therefore, it is more preferable to use a plurality of depth cameras and use a plurality of pieces of depth information.

Furthermore, on the basis of the image data and the above-mentioned mask information, the control value can be calculated more appropriately in consideration of the portion of the subject invisible from each camera 2.

Note that the creation unit 144a and the calculation unit 145a may operate as will be described below in consideration of the fact that the portion of the subject invisible from each camera 2 suddenly becomes visible. In that case, first, the creation unit 144a creates the depth information of the entire subject as the selected area information (including non-imageable part), which is the information regarding the area selected by the selection unit 143 for each of the plurality of pieces of image data. At this time, unlike the masked depth information, the depth information is created by using the entire area of the subject including the non-imageable part without taking occlusion into consideration. Then, the calculation unit 145a calculates the control value of each of the plurality of cameras 2 on the basis of the corresponding image data and the selected area information. In this way, the area hidden by another subject is also used for calculation of the control value. For example, the control value is hardly changed even in a case where the state in which most of the body of the person B is invisible by being hidden behind the rectangular parallelepiped A as in the masked image data of the camera 2A of FIG. 6(f) is changed such that either the person B or the rectangular parallelepiped A moves and the visible part of the body of the person B increases. That is, the control value can be stabilized in time.

### Third Embodiment

Next, a multi-camera system S of the third embodiment will be described. Duplicate description will be omitted as appropriate for matters similar to those of at least one of the first embodiment or the second embodiment.

In the first embodiment and the second embodiment, the difference in brightness and color of the images of the same subject imaged by the plurality of cameras 2 is not taken into consideration. This difference is due to, for example, differences in camera and lens manufacturers, manufacturing variations, differences in visible subject parts for each camera 2, optical characteristics of camera images in which brightness and color are different between the center and edges of the images, and the like. As a countermeasure against this difference, in the conventional technique, it is common to image the same subject with sufficient color information such as the Macbeth chart with a plurality of cameras, and the brightness and color are compared and adjusted to be the same. Therefore, it takes time and effort, which is an obstacle to increasing the number of cameras. In the third embodiment, this problem can be solved by automating the countermeasures against the difference.

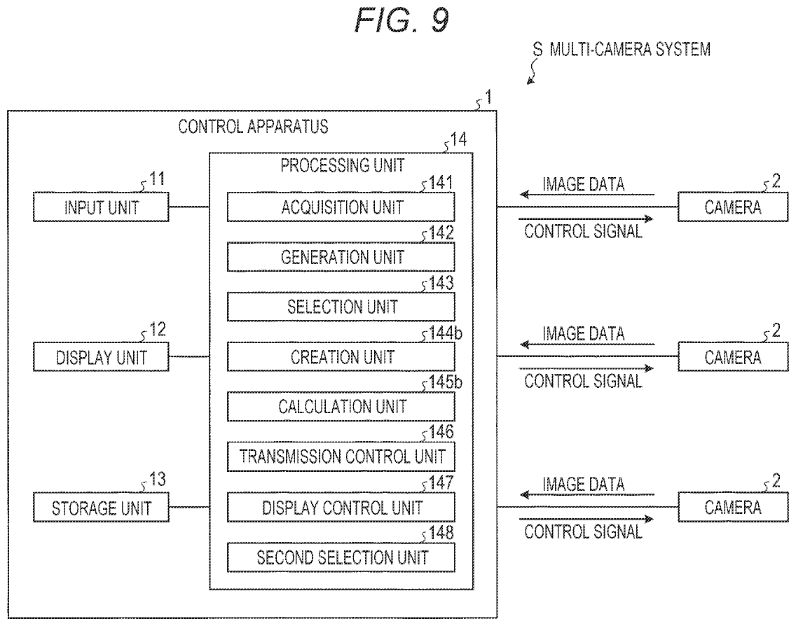

FIG. 9 is an overall configuration diagram of a multi-camera system S according to the third embodiment of the present disclosure. Compared with FIG. 1, it differs in that a second selection unit 148 is added to the processing unit 14 of the control apparatus 1. Note that a creation unit 144b and a calculation unit 145b are configurations corresponding to the creation unit 144 and the calculation unit 145 of FIG. 1, respectively.

The second selection unit 148 selects a reference camera for calculating the control values as a master camera from the plurality of cameras 2. In that case, the calculation unit 145b calculates the control value of each of the plurality of cameras 2 other than the master camera on the basis of the corresponding image data and mask information, and the color information of the image data of the master camera. Furthermore, the calculation unit 145b calculates the exposure time, ISO sensitivity, aperture value, white balance, and the like of the camera 2 as control values.

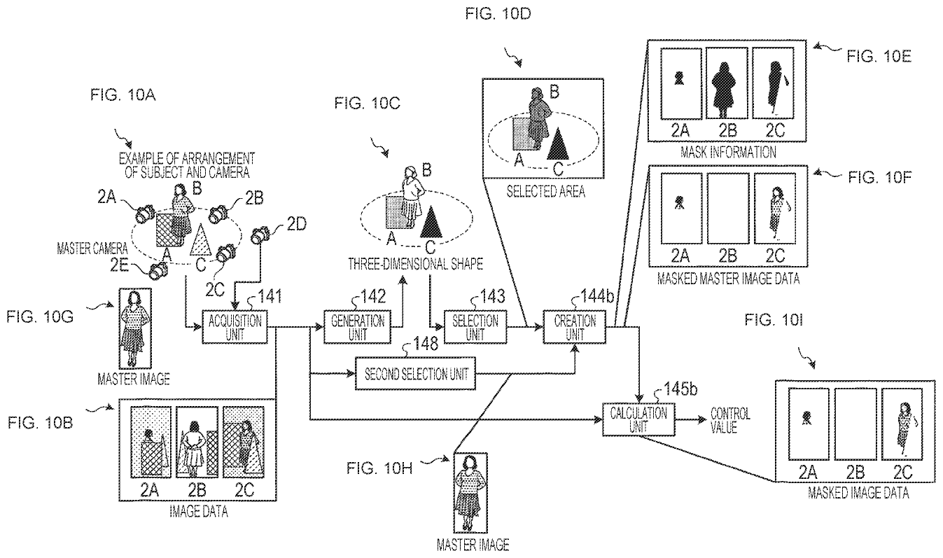

Here, FIG. 10 is an explanatory diagram of processing content of units 141 to 145b and 148 in the processing unit 14 of the control apparatus 1 according to the third embodiment of the present disclosure. A case where the control values of the cameras 2A, 2B, and 2C are calculated using an image of a master camera 2E shown in FIG. 10(a) will be considered below.

In this case, the acquisition unit 141 acquires pieces of image data (FIG. 10(b)) having different brightness and color from the cameras 2A, 2B, and 2C. Furthermore, the acquisition unit 141 acquires image data and depth information from a depth camera 2D and furthermore acquires image data (FIG. 10(g), “master image”) from the master camera 2E. Furthermore, the generation unit 142 (FIG. 10(c)) and the selection unit 143 (FIG. 10(d)) are similar to those in the case of the first embodiment.

The creation unit 144b creates mask information (FIG. 10(e)) similar to the case of the first embodiment, and moreover creates masked master image data (FIG. 10(f)) on the basis of the master image, the depth information, and the mask information.

Furthermore, the calculation unit 145b creates masked image data (FIG. 10(i)) on the basis of the image data of the cameras 2A, 2B, and 2C and the mask information. Then, the calculation unit 145b calculates the control value of each of the cameras 2A, 2B, and 2C on the basis of the corresponding masked image data (FIG. 10(i)) and masked master image data (FIG. 10(f)).

That is, the calculation unit 145b can calculate an appropriate control value by comparing and adjusting the color information of the corresponding portion of the masked image data (FIG. 10(i)) and the masked master image data (FIG. 10(f)).

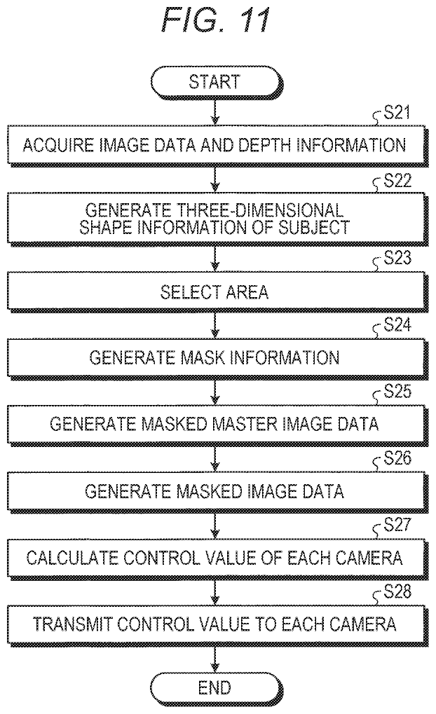

Next, the processing by the control apparatus 1 will be described with reference to FIG. 11. FIG. 11 is a flowchart showing processing by the control apparatus 1 according to the third embodiment of the present disclosure. First, in step S21, the acquisition unit 141 acquires the image data from each of the cameras 2A, 2B, 2C, and 2E and also acquires the depth information from the depth camera 2D.

Next, in step S22, the generation unit 142 generates the three-dimensional shape information for a subject in a predetermined imaging area on the basis of the plurality of pieces of image data acquired in step S21.

Next, in step S23, the selection unit 143 selects at least a partial area of the area represented by the three-dimensional shape information of the subject as the area for calculating the control value of each of the cameras 2A, 2B, and 2C.

Next, in step S24, the creation unit 144b creates the mask information, which is the information regarding the imageable part of the area selected in step S23 for each of the plurality of pieces of image data.

Next, in step S25, the creation unit 144b creates the masked master image data (FIG. 10(f)) on the basis of the master image, the depth information, and the mask information.

Next, in step S26, the calculation unit 145b creates the masked image data (FIG. 10(i)) on the basis of the image data of the cameras 2A, 2B, and 2C and the mask information.

Next, in step S27, the calculation unit 145b calculates the control value of each of the cameras 2A, 2B, and 2C on the basis of the corresponding masked image data (FIG. 10(i)) and masked master image data (FIG. 10(f)).

Next, in step S28, the transmission control unit 146 transmits a control signal including the control value calculated in step S26 to the camera 2 corresponding to the control value. Then, each of the plurality of cameras 2 performs imaging on the basis of the received control value.

As described above, with the multi-camera system S of the third embodiment, it is possible to totally optimize the control values and make the brightness and color of images of the same subject imaged by the plurality of cameras 2 uniform. Furthermore, in the third embodiment, the creation unit 144b may create selected area information (including non-imageable part), which is the information regarding the area selected by the selection unit 143, on the basis of the entire master image data. As compared with the masked master image data, by using the selected area information, the control value is calculated in consideration of the area that is originally invisible from the camera 2. Therefore, similar to the second embodiment, stable imaging becomes possible without sudden changes in the control value even in a scene where the selected subject pops out from behind a large obstacle.

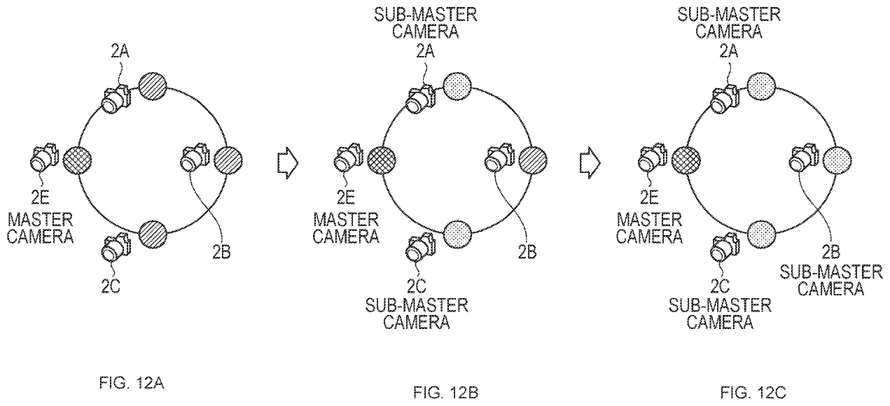

Next, a variation example of the third embodiment will be described. FIG. 12 is an explanatory diagram of the variation example of the third embodiment of the present disclosure. In a case where the number of master cameras is one, a reference image cannot be created for areas that are invisible in the master image. In such a case, a camera whose control value has been adjusted according to the master image can be used as a sub-master camera.

First, by adjusting the control values of the cameras 2A and 2C according to the master image of the master camera 2E, the cameras 2A and 2C can be handled as sub-master cameras 2A and 2C (FIGS. 12(a) and 12(b)). Next, by adjusting the control value of the camera 2B according to the master image of the master camera 2E and sub-master images of the sub-master cameras 2A and 2C, the camera 2B can be handled as a sub-master camera 2B (FIG. 12(c)). By propagating the reference in this way, the total optimization of the control value can be realized with higher accuracy.

Note that the present technology may be configured as below.

(1) A multi-camera system including:

a plurality of cameras configured to image a predetermined imaging area from different directions; and

a control apparatus configured to receive image data from each of a plurality of the cameras and transmit a control signal including a control value to each of a plurality of the cameras,

in which

the control apparatus includes:

an acquisition unit configured to acquire the image data from each of a plurality of the cameras;

a generation unit configured to generate three-dimensional shape information for a subject in the predetermined imaging area on the basis of a plurality of pieces of the image data;

a selection unit configured to select at least a partial area of an area represented by the three-dimensional shape information of the subject as an area for calculating the control value of each of a plurality of the cameras;

a creation unit configured to create mask information that is an image area used for control value calculation within the area selected by the selection unit for each of a plurality of pieces of the image data; and

a calculation unit configured to calculate the control value of each of a plurality of the cameras on the basis of the image data from each of a plurality of the cameras and the mask information.

(2) The multi-camera system according to (1), in which the selection unit selects the area on the basis of a selection operation on a screen by a user.

(3) The multi-camera system according to (1), in which

the creation unit further includes a function of creating selected area information that is information regarding the area selected by the selection unit for each of a plurality of pieces of the image data; and

the calculation unit calculates the control value of each of a plurality of the cameras on the basis of the corresponding image data and selected area information.

(4) The multi-camera system according to (1), in which

a plurality of the cameras includes a depth camera that calculates depth information that is information of a distance to the subject, and the acquisition unit acquires the depth information from the depth camera.

(5) The multi-camera system according to (1), in which

the creation unit further includes a function of creating mask information that is information regarding an imageable part of the area selected by the selection unit for each of a plurality of pieces of the image data and creating masked depth information that is a portion of depth information corresponding to the mask information for each of the cameras on the basis of the mask information and the depth information that is information of a distance to the subject; and

the calculation unit calculates the control value of each of a plurality of the cameras on the basis of the corresponding masked depth information.

(6) The multi-camera system according to (5), in which the calculation unit calculates at least one of an aperture value or a focal length of the camera as the control value.

(7) The multi-camera system according to (1), further including:

a second selection unit configured to select a reference camera for calculating the control value from a plurality of the cameras as a master camera,

in which

the calculation unit calculates the control value of each of a plurality of the cameras other than the master camera on the basis of the corresponding image data and mask information, and color information of image data of the master camera.

(8) The multi-camera system according to (7), in which

the calculation unit calculates at least one of exposure time, ISO sensitivity, aperture value, or white balance of the camera as the control value.

(9) A control value calculation method including:

an acquisition step of acquiring image data from each of a plurality of cameras configured to image a predetermined imaging area from different directions;

a generation step of generating three-dimensional shape information for a subject in the predetermined imaging area on the basis of a plurality of pieces of the image data;

a selection step of selecting at least a partial area of an area represented by the three-dimensional shape information of the subject as an area for calculating the control value of each of a plurality of the cameras;

a creation step of creating mask information that is an image area used for control value calculation within the area selected by the selection step for each of a plurality of pieces of the image data; and

a calculation step of calculating the control value of each of a plurality of the cameras on the basis of the image data from each of a plurality of the cameras and the mask information.

(10) A control apparatus including:

an acquisition unit configured to acquire image data from each of a plurality of cameras configured to image a predetermined imaging area from different directions;

a generation unit configured to generate three-dimensional shape information for a subject in the predetermined imaging area on the basis of a plurality of pieces of the image data;

a selection unit configured to select at least a partial area of an area represented by the three-dimensional shape information of the subject as an area for calculating the control value of each of a plurality of the cameras;

a creation unit configured to create mask information that is an image area used for control value calculation within the area selected by the selection unit for each of a plurality of pieces of the image data; and

a calculation unit configured to calculate the control value of each of a plurality of the cameras on the basis of the image data from each of a plurality of the cameras and the mask information.

(11) The control apparatus according to (10), in which

the selection unit selects the area on the basis of a selection operation on a screen by a user.

(12) The control apparatus according to (10), in which

the creation unit further includes a function of creating selected area information that is information regarding the area selected by the selection unit for each of a plurality of pieces of the image data; and

the calculation unit calculates the control value of each of a plurality of the cameras on the basis of the corresponding image data and selected area information.

(13) The control apparatus according to (10), in which

a plurality of the cameras includes a depth camera that calculates depth information that is information of a distance to the subject, and

the acquisition unit acquires the depth information from the depth camera.

(14) The control apparatus according to (10), in which

the creation unit further includes a function of creating mask information that is information regarding an imageable part of the area selected by the selection unit for each of a plurality of pieces of the image data and creating masked depth information that is a portion of depth information corresponding to the mask information for each of the cameras on the basis of the mask information and the depth information that is information of a distance to the subject; and

the calculation unit calculates the control value of each of a plurality of the cameras on the basis of the corresponding masked depth information.

(15) The control apparatus according to (10), further including:

a second selection unit configured to select a reference camera for calculating the control value from a plurality of the cameras as a master camera,

in which

the calculation unit calculates the control value of each of a plurality of the cameras other than the master camera on the basis of the corresponding image data and mask information, and color information of image data of the master camera.

Although the embodiments and variation examples of the present disclosure have been described above, the technical scope of the present disclosure is not limited to the above-described embodiments and variation examples as they are, and various changes can be made without departing from the gist of the present disclosure. Furthermore, the components of different embodiments and variation examples may be combined as appropriate.

For example, the control value is not limited to the above, but may be another control value such as a control value relating to the presence and absence and type of flash.

Furthermore, the number of cameras is not limited to three to five, but may be two or six or more.

Note that the effects of the embodiments and the variation examples described in the present description are merely illustrative and are not limitative, and other effects may be provided.

### REFERENCE SIGNS LIST

1 Control apparatus
2 Camera
11 Input unit
12 Display unit
13 Storage unit
14 Processing unit
141 Acquisition unit
142 Generation unit
143 Selection unit
144 Creation unit
145 Calculation unit
146 Transmission control unit
147 Display control unit
148 Second selection unit
A Rectangular parallelepiped
B Person
C Triangular pyramid

1. A multi-camera system comprising:
a plurality of cameras configured to image a predetermined imaging area from different directions; and
a control apparatus configured to receive image data from each of a plurality of the cameras and transmit a control signal including a control value to each of a plurality of the cameras,
wherein
the control apparatus includes:
an acquisition unit configured to acquire the image data from each of a plurality of the cameras;
a generation unit configured to generate three-dimensional shape information for a subject in the predetermined imaging area on a basis of a plurality of pieces of the image data;
a selection unit configured to select at least a partial area of an area represented by the three-dimensional shape information of the subject as an area for calculating the control value of each of a plurality of the cameras;
a creation unit configured to create mask information that is an image area used for control value calculation within the area selected by the selection unit for each of a plurality of pieces of the image data; and
a calculation unit configured to calculate the control value of each of a plurality of the cameras on a basis of the image data from each of a plurality of the cameras and the mask information.

2. The multi-camera system according to claim 1, wherein
the selection unit selects the area on a basis of a selection operation on a screen by a user.

3. The multi-camera system according to claim 1, wherein
the creation unit further includes a function of creating selected area information that is information regarding the area selected by the selection unit for each of a plurality of pieces of the image data; and
the calculation unit calculates the control value of each of a plurality of the cameras on a basis of the corresponding image data and selected area information.

4. The multi-camera system according to claim 1, wherein
a plurality of the cameras includes a depth camera that calculates depth information that is information of a distance to the subject, and
the acquisition unit acquires the depth information from the depth camera.

5. The multi-camera system according to claim 1, wherein
the creation unit further includes a function of creating mask information that is information regarding an imageable part of the area selected by the selection unit for each of a plurality of pieces of the image data and creating masked depth information that is a portion of depth information corresponding to the mask information for each of the cameras on a basis of the mask information and the depth information that is information of a distance to the subject; and
the calculation unit calculates the control value of each of a plurality of the cameras on a basis of the corresponding masked depth information.

6. The multi-camera system according to claim 5, wherein
the calculation unit calculates at least one of an aperture value or a focal length of the camera as the control value.

7. The multi-camera system according to claim 1, further comprising:
a second selection unit configured to select a reference camera for calculating the control value from a plurality of the cameras as a master camera,
wherein
the calculation unit calculates the control value of each of a plurality of the cameras other than the master camera on a basis of the corresponding image data and mask information, and color information of image data of the master camera.

8. The multi-camera system according to claim 7, wherein
the calculation unit calculates at least one of exposure time, ISO sensitivity, aperture value, or white balance of the camera as the control value.

9. A control value calculation method comprising:
an acquisition step of acquiring image data from each of a plurality of cameras configured to image a predetermined imaging area from different directions;
a generation step of generating three-dimensional shape information for a subject in the predetermined imaging area on a basis of a plurality of pieces of the image data;
a selection step of selecting at least a partial area of an area represented by the three-dimensional shape information of the subject as an area for calculating the control value of each of a plurality of the cameras;
a creation step of creating mask information that is an image area used for control value calculation within the area selected by the selection step for each of a plurality of pieces of the image data; and
a calculation step of calculating the control value of each of a plurality of the cameras on a basis of the image data from each of a plurality of the cameras and the mask information.

10. A control apparatus comprising:
an acquisition unit configured to acquire image data from each of a plurality of cameras configured to image a predetermined imaging area from different directions;
a generation unit configured to generate three-dimensional shape information for a subject in the predetermined imaging area on a basis of a plurality of pieces of the image data;
a selection unit configured to select at least a partial area of an area represented by the three-dimensional shape information of the subject as an area for calculating the control value of each of a plurality of the cameras;
a creation unit configured to create mask information that is an image area used for control value calculation within the area selected by the selection unit for each of a plurality of pieces of the image data; and
a calculation unit configured to calculate the control value of each of a plurality of the cameras on a basis of the image data from each of a plurality of the cameras and the mask information.

11. The control apparatus according to claim 10, wherein
the selection unit selects the area on a basis of a selection operation on a screen by a user.

12. The control apparatus according to claim 10, wherein
the creation unit further includes a function of creating selected area information that is information regarding the area selected by the selection unit for each of a plurality of pieces of the image data; and
the calculation unit calculates the control value of each of a plurality of the cameras on a basis of the corresponding image data and selected area information.

13. The control apparatus according to claim 10, wherein
a plurality of the cameras includes a depth camera that calculates depth information that is information of a distance to the subject, and
the acquisition unit acquires the depth information from the depth camera.

14. The control apparatus according to claim 10, wherein
the creation unit further includes a function of creating mask information that is information regarding an imageable part of the area selected by the selection unit for each of a plurality of pieces of the image data and creating masked depth information that is a portion of depth information corresponding to the mask information for each of the cameras on a basis of the mask information and the depth information that is information of a distance to the subject; and
the calculation unit calculates the control value of each of a plurality of the cameras on a basis of the corresponding masked depth information.

15. The control apparatus according to claim 10, further comprising:
a second selection unit configured to select a reference camera for calculating the control value from a plurality of the cameras as a master camera,
wherein
the calculation unit calculates the control value of each of a plurality of the cameras other than the master camera on a basis of the corresponding image data and mask information, and color information of image data of the master camera.
